(19) United States
(12) Patent Application Publication
(10) Pub. No.: US 2004/0095841 A1
(43) Pub. Date: May 20, 2004

(54) Portable variable speed volumetric feed hopper

(76) Inventors: Mark Preisser, Kearney, MO (US); Robert J. Fox, Kiel, WI (US)

Correspondence Address: LITTMAN LAW OFFICES, LTD., P.O. BOX 15035 CRYSTAL CITY STATION, ARLINGTON, VA, 22215, US

(21) Appl. No.: 10/299,829

(22) Filed: Nov. 20, 2002

(51) Int. Cl. B01F 15/02

(52) U.S. Cl. 366/50; 366/186

(57) ABSTRACT

A volumetric feed hopper is provided with a variable speed drive to vary the feed rate of the hopper. The hopper is further provided with adjustable legs with pivoting feet to enable the hopper to be installed a various heights and on uneven surfaces.

### BACKGROUND OF THE INVENTION

1. Field of the Invention

The present invention relates to a portable feed hopper for a concrete reclaiming apparatus, and more particularly to a portable variable speed volumetric feed hopper.

2. Description of the Related Art

The related art shows that apparatus for reclaiming the aggregates of unused concrete is well known. For example, U.S. Pat. No. 4,127,487 issued Nov. 28, 1978 to Miller teaches a machine for salvaging waste concrete material. Miller teaches the use of a hopper fixed on the machine for receiving residual mixed concrete from ready mix trucks. A movable apertured disc at a lower end of the hopper starts and stop the flow of rinse water mixed with concrete from the hopper into the machine. The Miller machine has the disadvantage of not having a means for controlling the efficiency of the reclaiming process when, for example, a concrete with different aggregate content is being reclaimed.

In U.S. Pat. No. 3,885,774 issued May 27, 1975 to Harris et al., an apparatus is shown for preparing and dispensing mixtures of concrete and fibers. Materials for the concrete mix are provided in 3 hoppers. The proportions of the cement and aggregate are varied by adjusting the gearing in the drive of the hopper feed screw or using feed screws having different dimensions, flights or pitch in the various hoppers.

U.S. Pat. No. 6,325,311 issued Dec. 4, 2001 to Preisser shows that the use of constant feed hoppers attached at the input of concrete reclaimers to supply unused concrete from cement trucks into the reclaimers is also known in the field of concrete reclaiming.

None of the above inventions and patents, taken either singularly or in combination, is seen to describe the instant invention as claimed. Thus a variable speed volumetric feed hopper solving the aforementioned problems is desired.

### SUMMARY OF THE INVENTION

The present invention is a portable volumetric feed hopper for concrete reclaiming apparatus that is supported upon adjustable legs to enable the hopper to be installed at different of heights above the ground. Each leg includes a pivoting foot to enable installation of the hopper on uneven surfaces. The hopper includes a variable speed drive to enable the feed rate of the hopper to be adjusted to the optimal rate for any particular make or style of concrete reclaimer.

Accordingly, it is a principal object of the invention to provide a variable speed volumetric feed hopper having adjustable legs with pivoting feet that can be positioned to supply concrete to different types of concrete reclaiming devices at an optimum feed rate for each particular device.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a variable speed volumetric feed hopper according to the present invention.

FIG. 2 is a front view of the variable speed feed hopper according to the present invention.

FIG. 3 is a top view of the variable speed feed hopper according to the present invention.

FIG. 4 is a side view of the variable feed hopper in a raised position.

FIG. 5 is a side view of the variable feed hopper in a raised position.

FIG. 6 is an enlarged side view of a pivoting foot attached to a leg of the hopper.

FIG. 7 is a cross-sectional view of the pivoting foot according to the present invention taken along line 7-7 of FIG. 6.

Similar reference characters denote corresponding features consistently throughout the attached drawings.

### DETAILED DESCRIPTION OF THE PREFERRED EMBODIMENT

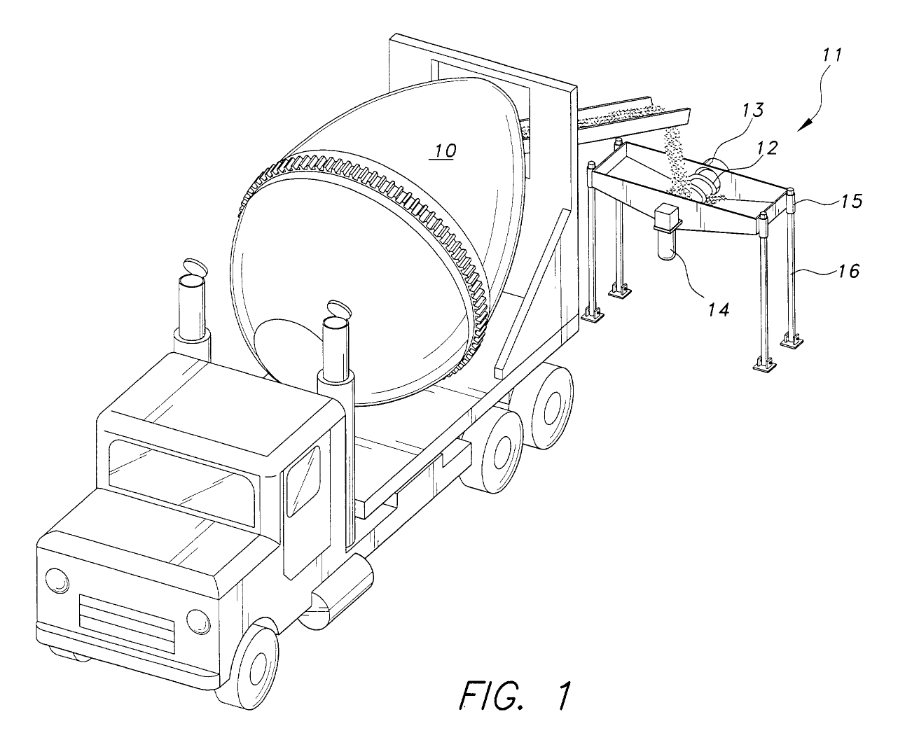

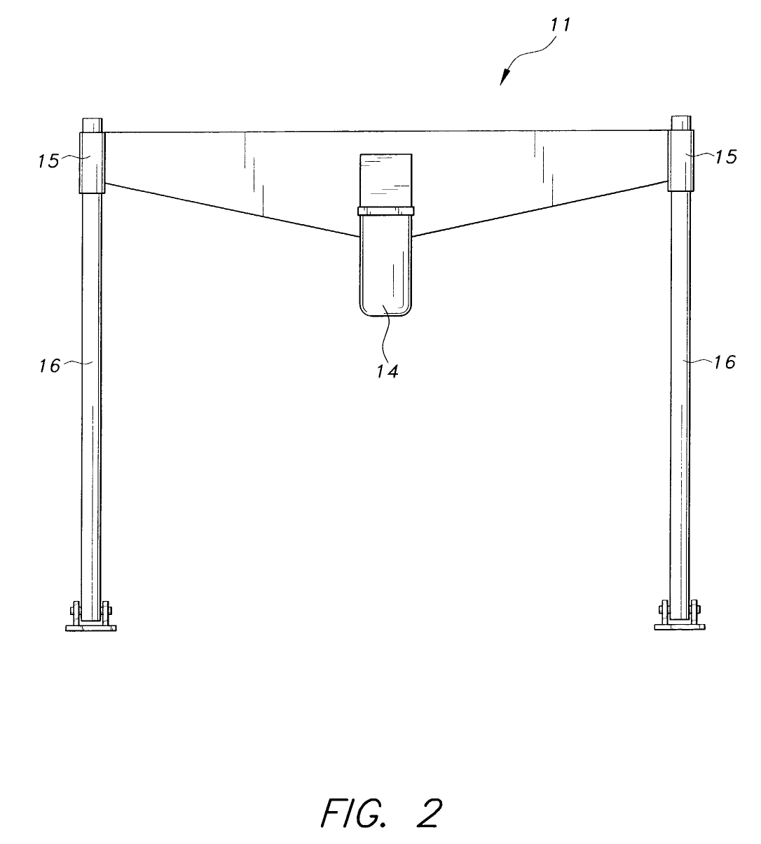

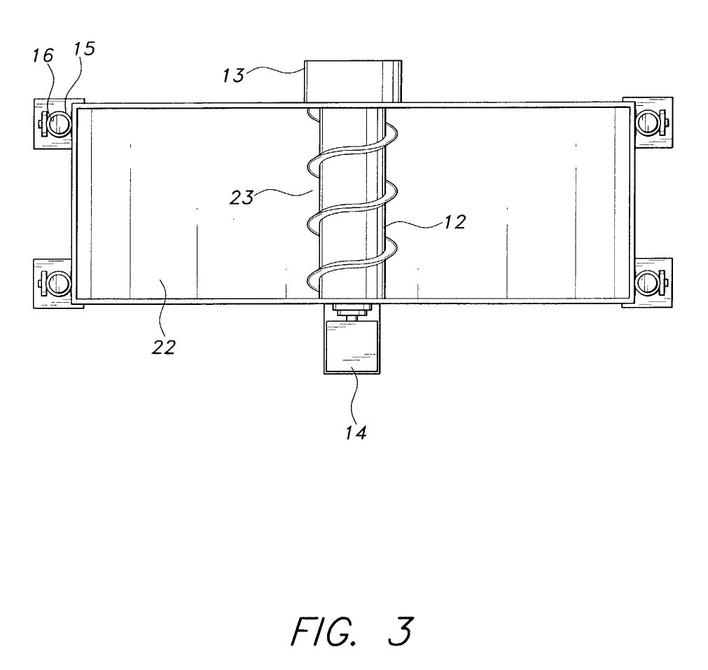

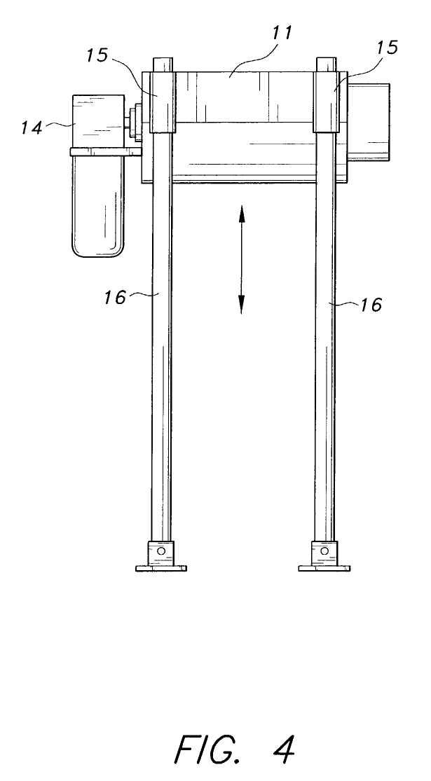

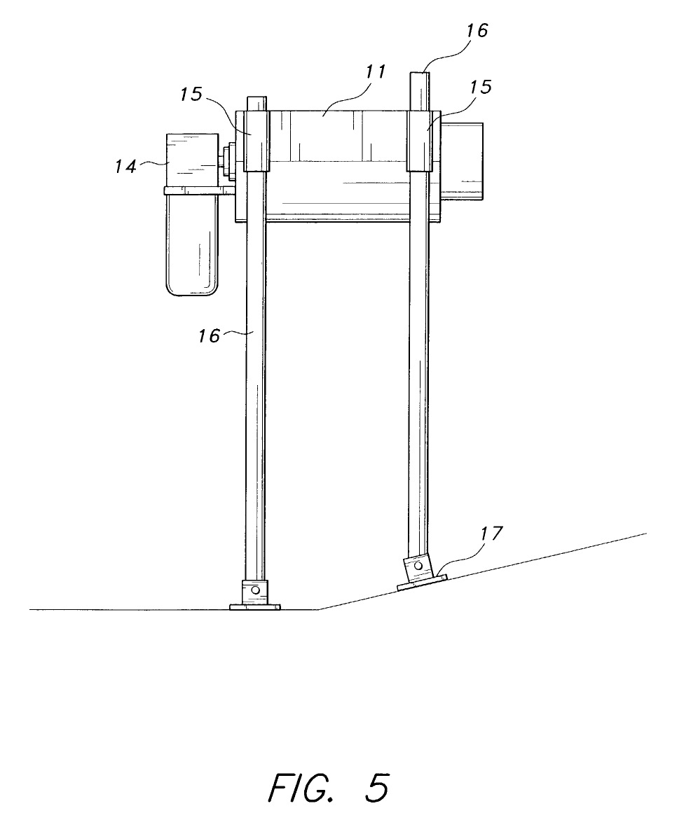

The present invention is a portable volumetric feed hopper that is supported by adjustable legs to enable the hopper to be installed at a variety of heights. As shown in FIG. 1, the hopper 11 includes a volumetric feet screw 12 for feeding concrete through and outlet 13. The feed screw 12 is provided within a feed channel 23 formed in the bottom wall 22 of the hopper 11.

Each corner of the hopper 11 includes a cylindrical sleeve 15 for adjustably receiving and locking into place a leg 16. Locking of the leg 16 is carried out by any suitable means, such as a pin passing through alignable holes in the sleeve and leg for example. The adjustable legs 16 enable the hopper 11 to be positioned at various heights.

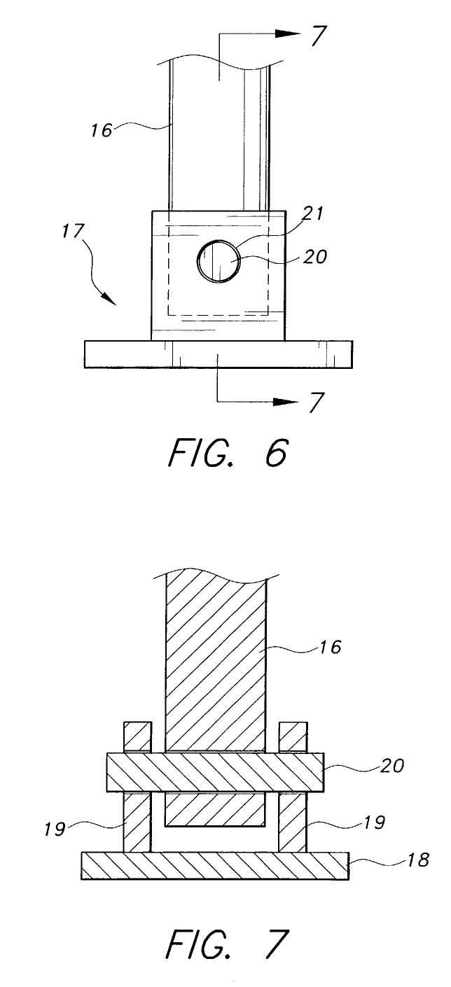

The lower end of each leg 16 of the hopper includes an aperture for receiving a pivot pin 20. The pivot pin 20 is also received in apertures 21 formed in arms 19 extending from the base portion 18 of a foot 17. See FIGS. 6 and 7. The ground engaging pivoting feet 17 of the hopper 11 enable the hopper 11 to be installed on uneven surfaces. The adjustable legs 16 and pivoting feet 17 of the hopper 11 together not only enables the hopper 11 to be positioned at the input of different types of concrete reclaimers but also enables the hopper 11 to be supported on flat or uneven surfaces.

A variable speed drive 14 is provided for driving the feed screw 12 to enable the feed rate of the hopper 11 to be adjusted to a rate as required for optimum performance of various concrete reclaimers.

It is to be understood that the present invention is not limited to the embodiment described above, but encompasses any and all embodiments within the scope of the following claims.

We claim:

1. A portable variable speed volumetric feed hopper comprising:
a hopper having a discharge outlet;
means within said hopper for volumetrically feeding concrete through said discharge outlet;
means operatively connected to said volumetric feeding means for varying the feed rate of concrete through said discharge outlet; and
means for adjustably supporting said hopper at a selected height above the ground.

2. The portable variable speed volumetric feed hopper according to claim 1, wherein said means for volumetrically feeding concrete through said discharge outlet is in the form of a recessed feed channel in the bottom of the hopper and a feed screw operatively positioned within said channel.

3. The portable variable speed volumetric feed hopper according to claim 2, wherein said means for varying the feed rate is in the form of a variable speed drive operatively position on said hopper for driving said feed screw.

4. The portable variable speed volumetric feed hopper according to claim 3, wherein said means for adjustably supporting said hopper above the ground includes a tubular sleeve and a tubular leg, on each corner of said hopper, said tubular sleeve adjustably receiving and locking said tubular leg.

5. The portable variable speed volumetric feed hopper according to claim 4, further including means for adapting the legs for mounting upon uneven surfaces.

6. The portable variable speed volumetric feed hopper according to claim 5, wherein the means for adapting the legs for mounting upon uneven surfaces is in the form of an aperture through a lower end of each leg, a foot having a base portion for resting upon the ground and two parallel apertured support arms extending upwardly from said base portion of said foot, and a pivot pin passing through the leg and support arm apertures for pivotally attaching said foot to said leg.

7. The portable variable speed volumetric feed hopper according to claim 2, wherein said means for adjustably supporting said hopper above the ground includes a tubular sleeve and a tubular leg, on each corner of said hopper, said tubular sleeve adjustably receiving and locking said tubular leg.

8. The portable variable speed volumetric feed hopper according to claim 7, further including means for adapting the legs for mounting upon uneven surfaces.

9. The portable variable speed volumetric feed hopper according to claim 8, wherein the means for adapting the legs for mounting upon uneven surfaces is in the form of an aperture through a lower end of each leg, a foot having a base portion for resting upon the ground and two parallel apertured support arms extending upwardly from said base portion of said foot, and a pivot pin passing through the leg and support arm apertures for pivotally attaching said foot to said leg.

10. The portable variable speed volumetric feed hopper according to claim 1, wherein said means for varying the feed rate is in the form of a variable speed drive.

11. The portable variable speed volumetric feed hopper according to claim 10, wherein said means for adjustably supporting said hopper above the ground includes a tubular sleeve and a tubular leg, on each corner of said hopper, said tubular sleeve adjustably receiving and locking said tubular leg.

12. The portable variable speed volumetric feed hopper according to claim 11, further including means for adapting the legs for mounting upon uneven surfaces.

13. The portable variable speed volumetric feed hopper according to claim 12, wherein the means for adapting the legs for mounting upon uneven surfaces is in the form of an aperture through a lower end of each leg, a foot having a base portion for resting upon the ground and two parallel apertured support arms extending upwardly from said base portion of said foot, and a pivot pin passing through the leg and support arm apertures for pivotally attaching said foot to said leg.

14. The portable variable speed volumetric feed hopper according to claim 1, wherein said means for adjustably supporting said hopper above the ground includes a tubular sleeve and a tubular leg, on each corner of said hopper, said tubular sleeve adjustably receiving and locking said tubular leg.

15. The portable variable speed volumetric feed hopper according to claim 14, further including means for adapting the legs for mounting upon uneven surfaces.

16. The portable variable speed volumetric feed hopper according to claim 15, wherein the means for adapting the legs for mounting upon uneven surfaces is in the form of an aperture through a lower end of each leg, a foot having a base portion for resting upon the ground and two parallel apertured support arms extending upwardly from said base portion of said foot, and a pivot pin passing through the leg and support arm apertures for pivotally attaching said foot to said leg.

17. The portable variable speed volumetric feed hopper according to claim 1, further including means for adapting the legs for mounting upon uneven surfaces.

18. The portable variable speed volumetric feed hopper according to claim 17, wherein the means for adapting the legs for mounting upon uneven surfaces is in the form of an aperture through a lower end of each leg, a foot having a base portion for resting upon the ground and two parallel apertured support arms extending upwardly from said base portion of said foot, and a pivot pin passing through the leg and support arm apertures for pivotally attaching said foot to said leg.

19. A portable variable speed volumetric feed hopper comprising:
a hopper having a discharge outlet;
means within said hopper for volumetrically feeding concrete through said discharge outlet;
means operatively connected to said volumetric feeding means for varying the feed rate of concrete through said discharge outlet;
means for adjustably supporting said hopper at a selected height above the ground;
wherein said means for volumetrically feeding concrete through said discharge outlet is in the form of a recessed feed channel in the bottom of the hopper and a feed screw operatively positioned within said channel and said means for varying the feed rate is in the form of a variable speed drive operatively position on said hopper for driving said feed screw; and
further including means for adapting the legs for mounting upon uneven surfaces

20. The portable variable speed volumetric feed hopper according to claim 19, wherein the means for adapting the legs for mounting upon uneven surfaces is in the form of an aperture through a lower end of each leg, a foot having a base portion for resting upon the ground and two parallel support arms extending upwardly from said base portion of said foot and having apertures therein, and a pivot pin passing through the leg and support arm apertures for pivotally attaching said foot to said leg.
